(19) United States
(12) Patent Application Publication
(10) Pub. No.: US 2005/0216934 A1
(43) Pub. Date: Sep. 29, 2005

(54) Central management of localized programming

(75) Inventors: Mitchell J. Weinraub, Centennial, CO (US); Gary Traver, Parker, CO (US)

Correspondence Address: BROOKS KUSHMAN P.C., 1000 TOWN CENTER, TWENTY-SECOND FLOOR, SOUTHFIELD, MI, 48075, US

(73) Assignee: Comcast Cable Holdings, LLC, Philadelphia, PA (US)

(21) Appl. No.: 10/810,941

(22) Filed: Mar. 26, 2004

(51) Int. Cl. H04N 7/025; H04N 7/10; H04N 7/173

(52) U.S. Cl. 725/36

(57) ABSTRACT

A method and system for the centralized managing of localized programming in a cable television network are provided. A local service area served by the cable television network headend has a channel lineup, including a network channel carrying network broadcast programming. An electronic video playback device is located in the cable television network and is associated with the local service area. Non-live content is provided to a central facility where the content is encoded to create files. The files, along with custom schedules or play lists for each market, are then distributed to the appropriate market via an addressable content delivery network. The local electronic video playback device for the service area plays the localized content files or passes network channel content.

### BACKGROUND OF THE INVENTION

1. Field of the Invention

The invention relates to providing localized programming and to content management.

2. Background Art

The typical implementation of a cable television network in a local area uses coax cable for distribution through the local neighborhoods. The distribution signals originate at a cable television network headend. The headend may distribute over a hybrid fiber coax (HFC) network in a modern implementation of the cable television network.

The headend is associated with a particular geographic area. The headend receives content from various sources for distribution through its overall service area. The received content includes network channel content. The typical cable television channel lineup in a service area includes a number of network channels, each carrying national broadcast programming. The network channel approach provides economies of scale for the network channel provider. But the typical network channel itself is a one-size-fits-all approach that lacks localization.

In one existing arrangement, a national network television channel broadcasts national weather information. The national television channel sends local weather information to computers at local headends. Simultaneously and universally, the computers, at a predetermined time, send out the local weather information. In this way, local weather information is received in each locality on the channel at the same time. So, this one existing arrangement does address the problem of lack of localization typically occurring with a network channel. But even in this arrangement, local programming scheduling is subjected to a rigid national structure.

There are also a number of local independent television stations. And there are also a number of local affiliate television stations. A local affiliate station receives a national feed from the national network and on occasion broadcasts local programming instead of broadcasting the national feed. But in this arrangement, national networks and local affiliate broadcasting stations are always involved.

Further background information may be found in Frederick M. Baumgartner, “Building ADMC's Third Party DTV Central Casting System,” presented at National Association of Broadcasters Convention 2002.

Although there are some existing attempts to localize content in a network television channel or an affiliated local television station, there is a need for improved central management of localized programming in a cable television network.

### SUMMARY OF THE INVENTION

It is an object of the invention to provide improved central management of localized programming in a cable television network. In the improved methods and systems, non-live content is provided to a central facility where the content is encoded to create files. The files, along with custom schedules or play lists for each market, are then distributed to the appropriate markets via an addressable content delivery network.

In carrying out the invention, a method and system for the centralized managing of localized programming in a cable television network are provided. The cable television network includes a headend. The cable television distributed signals originate at the headend. The headend receives content for distribution from content sources. A local service area served by the headend has a channel lineup including a network channel carrying network broadcast programming. An electronic video playback device is located in the cable television network and is associated with the local service area.

In an aspect of the invention, non-live content is provided to a central facility where the content is encoded to create files. The files, along with custom schedules or play lists for each market, are then distributed to the appropriate markets via an addressable content delivery network.

More specifically, for the local service area served by the headend, created files and associated playback schedules for the created files are delivered to the electronic video playback device associated with the local service area. The delivery occurs over an addressable content delivery network, which may or may not include parts of the cable television network.

At a more detailed level, the invention comprehends central management of localized programming. The local electronic video playback device for the service area plays the localized content files or passes network channel content. The local device functions independently of other local devices. In this way, localized programming may be played on a schedule deemed appropriate for the particular locality without being bound by a strict national structure.

Advantages associated with embodiments of the invention are numerous. Embodiments of the invention localize programming over a channel independently from locality to locality and rigid national structures are avoided. Embodiments of the invention localize programming over a channel using a local playback device in a cable television network, which provides individualized local programming schedules over a true network channel. Embodiments of the invention may play back localized programming without the need for local action to be taken.

### BRIEF DESCRIPTION OF THE DRAWINGS

FIG. 1 illustrates a cable television network implementation in an embodiment of the invention;

FIG. 2 illustrates a cable television network implementation in a second embodiment of the invention; and

FIG. 3 illustrates a method as an embodiment of the invention.

### DETAILED DESCRIPTION OF THE PREFERRED EMBODIMENTS

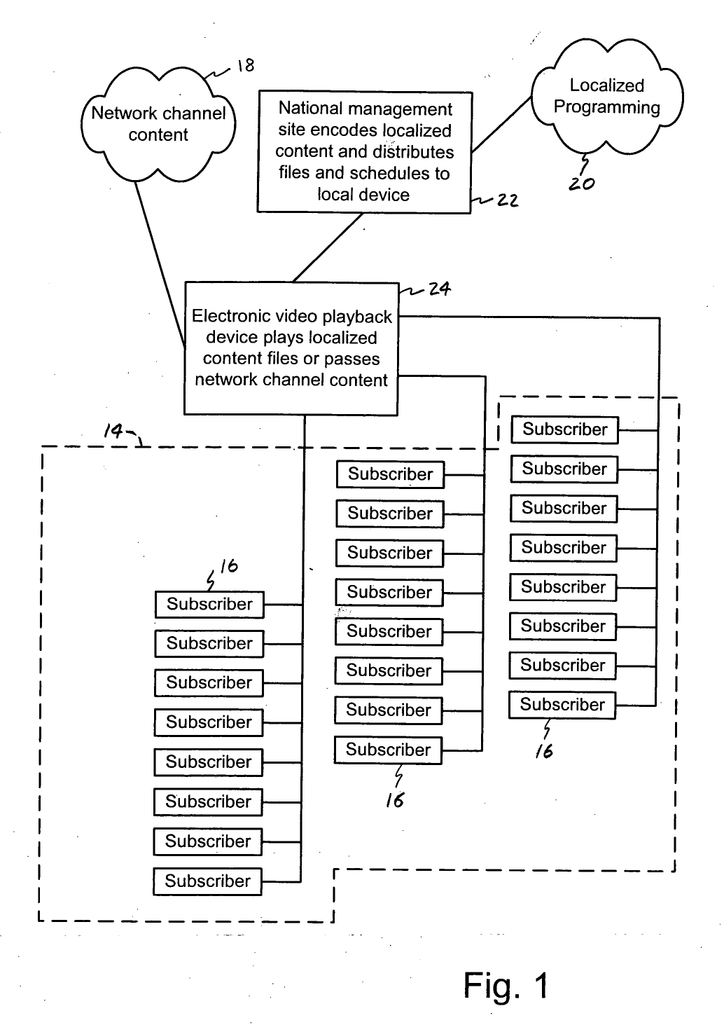

With reference to FIG. 1, a cable television network includes a headend that distributes cable television signals over a hybrid fiber coax (HFC) network. The network is illustrated in a simplified fashion with distribution of the cable television signals to local service area 14. Local service area 14 serves subscribers 16. Local service area 14 has a channel lineup which includes a network channel carrying network broadcast programming that is received from network channel content source 18. The channel lineup may include any number of additional network channels and other channels as well.

In addition to receiving network channel content, local service area 14 also receives localized programming. The localized programming is centrally managed. More specifically, localized programming 20 is provided to a national management site 22. The national management site 22 receives the non-live content and encodes the non-live content to create at least one file and an associated play schedule. National management site 22 distributes the at least one file and the associated play schedule to electronic video playback device 24, which is associated with local service area 14 and which is part of the cable television network. In this illustrated embodiment, reference number 24 also indicates the headend, which contains the video playback device.

Electronic video playback device 24 is programmed to play received files representing local programming as video programming (for example, HD or NTSC, etc., that is, in a linear video stream as opposed to a traditional file transfer, that is, in the same general way as other channels are sent in video form as opposed to a file transfer approach) over the network channel according to the associated received play schedules. That is, device 24 plays files over the network channel according to associated play schedules, but otherwise passes regular network channel carried network broadcast programming over the network channel. In this way, local non-live content play scheduling may be centrally managed for the local service area.

Put another way, subscribers 16 normally receive the regular network scheduled network broadcast programming over the particular network channel of interest, except in the case where a play schedule at device 24 for a file containing non-live local programming dictates that the local programming is to be played in place of the regularly scheduled network content. It is also possible that the network channel leaves certain time slots open for the insertion of local programming. In this way, localized programming may be provided over a network channel carrying network broadcast programming by using files and play lists at an electronic video playback device 24 associated with the local service area 14. National management site 22 allows central management of this process.

As illustrated, electronic video playback device 24 is connected to national management site 22 over an addressable content delivery network. In the illustrated embodiment, this addressable content delivery network is independent of the cable television network.

It is appreciated that various components of the cable television distribution network may be implemented in any suitable fashion. Further, network channel content 18 may be received by the headend in any known manner. As well, distribution may take place in any suitable way. Electronic video playback device 24 may take any appropriate form of a device that allows files to be played according to a schedule and that is capable of passing network channel content or, as appropriate, preempting network channel content with localized programming. More specifically, electronic video playback device 24 may be a programmed computer or other suitable programmable device located along the cable television distribution network between the headend and the local service area 14.

National management site 22 and the addressable content delivery network may also take any suitable form. Further, as illustrated, national management site 22 functions as the central management facility, but centralization may occur on other levels besides the national level.

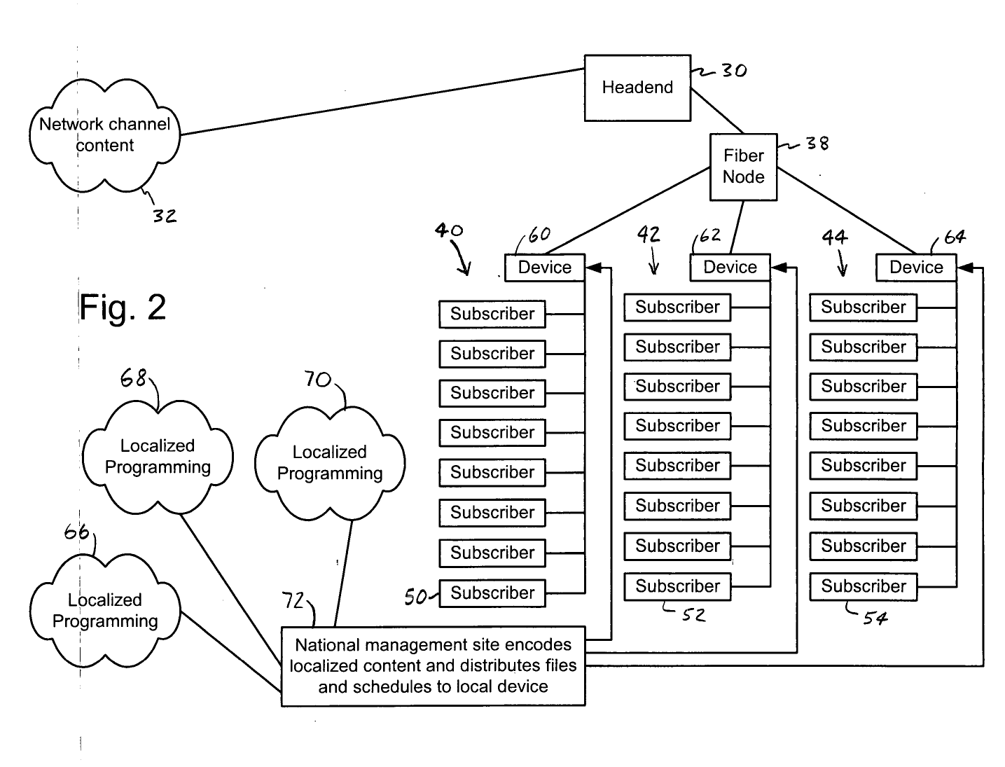

With reference to FIG. 2, a cable television network implementation is illustrated where multiple service areas and multiple electronic video playback devices are shown. Headend 30 receives network channel content from source 32. The network is still shown in a simplified fashion with headend 30 distributing cable television signals to fiber node 38. In this embodiment, three local service areas 40,42,44 are shown being served from fiber node 38. Local service areas 40,42,44 include subscribers 50,52,54, respectively.

In this embodiment, each local service area 40,42,44 has a corresponding electronic video playback device 60,62,64, respectively. The central management facility is implemented as national management site 72, which encodes localized content and distributes files and schedules to local devices 60,62,64. Localized programming is indicated at 66,68,70. National management site 72 processes non-live content from local programming sources 66,68,70 to create files and associated play schedules. The files and play schedules are distributed from national management site 72 to devices 60,62,64, as appropriate. Each electronic video playback device is programmed to play files as video programming over the network channel according to associated play schedules and otherwise to pass the network channel carried network broadcast programming over the network channel. As best illustrated in FIG. 2, local non-live content play scheduling is centrally managed at national management encoding and distribution site 72 for the plurality of local service areas 40,42,44, while at the same time independently controlled for each local service area by electronic video playback devices 60,62,64.

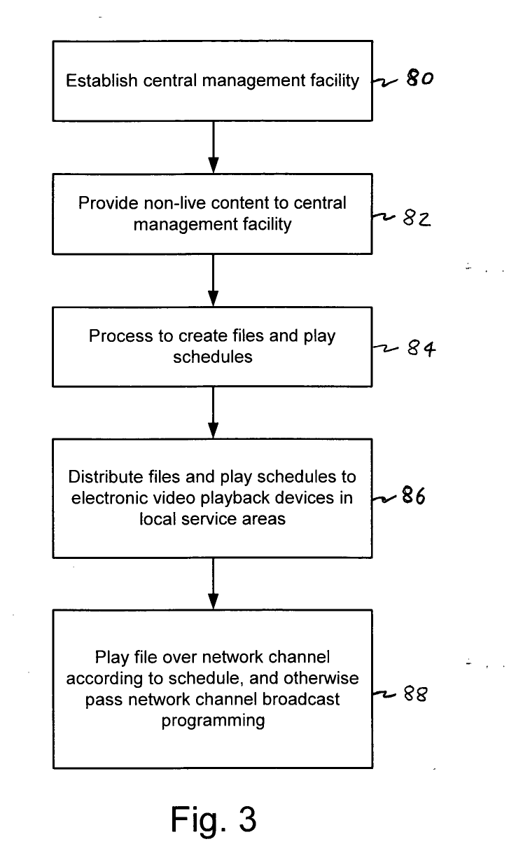

FIG. 3 illustrates a method for centrally managing localized programming in a cable television network. At block 80, a central management facility is established. For example, the central management facility may be implemented as a national management site, as illustrated in FIGS. 1 and 2. At block 82, non-live content is provided to the central management facility. At block 84, the non-live content is processed to create files and play schedules.

At block 86, the files and play schedules are distributed to electronic video playback devices in local service areas. At block 88, files are played over the network channel as video programming according to schedules, and otherwise network channel broadcast programming is played over the network channel. In this way, the network channel broadcast programming is preempted by the local programming according to the schedule. Overall, this allows local non-live content play scheduling to be centrally managed at a central management facility, while at the same time independently controlled on a locality by locality basis by providing appropriate files and schedules to each electronic video playback device.

It is appreciated that embodiments of the invention utilize a network broadcast channel and local playback devices to provide localized programming on a network channel. The use of a single network channel must be appreciated in that a single network channel is localized on a locality by locality basis yet the localizing techniques are managed centrally. It also must be appreciated that the invention utilizes local programming scheduling independently from locality to locality as opposed to rigid national structure. Localized programming may be played back without the need for local action to be taken.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A method for centrally managing localized programming in a cable television network, the cable television network including a headend, distributed cable television signals originating at the headend and the headend receiving content for distribution from a content source, wherein a local service area served by the headend has a channel lineup including a network channel carrying network broadcast programming, and wherein the cable television network includes an electronic video playback device associated with the local service area, the method comprising:
establishing a central management facility;
providing non-live content to the central management facility;
processing the non-live content at the central management facility to create at least one file and an associated play schedule;
distributing the at least one file and the associated play schedule to the electronic video playback device which is associated with the local service area and which is part of the cable television network; and
playing the at least one file as video programming over the network channel according to the associated play schedule and otherwise passing the network channel carried network broadcast programming over the network channel whereby local non-live content play scheduling may be centrally managed for multiple local service areas and may be independently controlled from local service area to local service area.

2. The method of claim 1 wherein the central management facility is in communication with the electronic video playback device over an addressable content delivery network, and wherein distributing further comprises:
distributing the at least one file and the associated play schedule to the electronic video playback device over the addressable content delivery network.

3. The method of claim 2 wherein addressable content delivery network is independent of the cable television network.

4. A method for centrally managing localized programming in a cable television network, the cable television network including a headend, distributed cable television signals originating at the headend and the headend receiving content for distribution from a content source, wherein a plurality of local service areas are served by the headend and each has a channel lineup including a network channel carrying network broadcast programming, and wherein the cable television network includes an electronic video playback device associated with each local service area, the method comprising:
establishing a central management facility;
providing non-live content to the central management facility;
processing the non-live content at the central management facility to create at least one file and an associated play schedule;
distributing the at least one file and the associated play schedule to the electronic video playback devices which are associated with the local service areas and which are part of the cable television network; and
at each electronic video playback device, playing the at least one file as video programming over the network channel according to the associated play schedule and otherwise passing the network channel carried network broadcast programming over the network channel whereby local non-live content play scheduling may be centrally managed for the plurality of local service areas and may be independently controlled for each local service area.

5. The method of claim 4 wherein the central management facility is in communication with the electronic video playback devices over an addressable content delivery network, and wherein distributing further comprises:
distributing the at least one file and the associated play schedule to the electronic video playback devices over the addressable content delivery network.

6. The method of claim 5 wherein addressable content delivery network is independent of the cable television network.

7. A system for centrally managing localized programming in a cable television network, the cable television network including a headend, distributed cable television signals originating at the headend and the headend receiving content for distribution from a content source, wherein a local service area served by the headend has a channel lineup including a network channel carrying network broadcast programming, the system comprising:
an electronic video playback device associated with the local service area; and
a central management facility for receiving non-live content, for processing the non-live content to create at least one file and an associated play schedule, and for distributing the at least one file and the associated play schedule to the electronic video playback device which is associated with the local service area and which is part of the cable television network,
wherein the electronic video playback device is programmed to play the at least one file as video programming over the network channel according to the associated play schedule and otherwise pass the network channel carried network broadcast programming over the network channel whereby local non-live content play scheduling may be centrally managed for multiple local service areas and may be independently controlled from local service area to local service area.

8. The system of claim 7 further comprising:
an addressable content delivery network connecting the central management facility with the electronic video playback device.

9. The system of claim 8 wherein addressable content delivery network is independent of the cable television network.

10. A system for centrally managing localized programming in a cable television network, the cable television network including a headend, distributed cable television signals originating at the headend and the headend receiving content for distribution from a content source, wherein a plurality of local service areas are served by the headend and each has a channel lineup including a network channel carrying network broadcast programming, the system comprising:
a plurality of electronic video playback devices each being associated with a local service area; and
a central management facility for receiving non-live content, for processing the non-live content to create at least one file and an associated play schedule, and for distributing the at least one file and the associated play schedule to the electronic video playback devices which are associated with the local service area and which are part of the cable television network,
wherein the electronic video playback devices are programmed to play the at least one file as video programming over the network channel according to the associated play schedule and otherwise pass the network channel carried network broadcast programming over the network channel whereby local non-live content play scheduling may be centrally managed for the plurality of local service areas and may be independently controlled for each local service area.

11. The system of claim 10 further comprising:
an addressable content delivery network connecting the central management facility with the electronic video playback devices.

12. The system of claim 11 wherein addressable content delivery network is independent of the cable television network.
